(19) United States
(12) Patent Application Publication
(10) Pub. No.: US 2003/0012537 A1
(43) Pub. Date: Jan. 16, 2003

(54) Method of forming an optical component

(76) Inventors: Chi Wu, San Marino, CA (US); Zhian Shao, Torrance, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/903,415

(22) Filed: Jul. 11, 2001

(51) Int. Cl. G02B 6/10; C03B 37/022; G02B 6/26

(52) U.S. Cl. 385/129; 65/386; 385/31

(57) ABSTRACT

A method of forming an optical component is disclosed. The method includes forming a first medium on a base. The base has one or more pockets defined in a side of the base. The first medium is formed on the base such that the first medium is positioned over the one or more pockets. The method also includes converting at least a portion of the first medium to a light transmitting medium.

### RELATED APPLICATIONS

This application is related to U.S. patent application Ser. No. 09/723,764, filed on Nov. 28, 2000, entitled “Silica Waveguide”; U.S. patent application Ser. No. 09/784,636, filed on Feb. 15, 2001, entitled “Component Having a Reduced Thermal Sensitivity”; U.S. patent application Ser. No. 09/784,814, filed on Feb. 15, 2001, entitled “Component Having Reduced Cross Talk”; U.S. patent application Ser. No. 09/821,822, filed on Mar. 29, 2001, entitled “Waveguide Having Light Barrier that Serves as Alignment Groove”; U.S. patent application Ser. No. 09/724,173, filed on Nov. 28, 2000, entitled “Demultiplexer Having a Compact Light Distributor”; and Provisional Patent application serial No. 60/239,534, filed on Oct. 10, 2000, entitled “A Compact Integrated Based Arrayed Waveguide Demultiplexer”. Each of the above related applications are incorporated herein in its entirety.

### BACKGROUND

1. Field of the Invention

The invention relates to one or more optical networking components. In particular, the invention relates to components having waveguides.

2. Background of the Invention

Optical networks employ a variety of optical components for processing of light signals. The optical components often include one or more waveguides that carry the light signals. These optical components are often formed from a component having a light transmitting medium positioned over a base. The light transmitting medium is etched to define the waveguides in the light transmitting medium.

The component can be formed by bonding the light transmitting medium to the base using wafer bonding techniques. In some instances, the base is constructed from silicon and the light transmitting medium is an oxide wafer. However, an undesirably low yield can result when bonding a thick oxide wafer to a silicon base. As a result, there is a need for a component having an increased yield.

Additionally, the light transmitting medium and the base often have different coefficients of thermal expansion. The different coefficients of thermal expansion can cause warping of the optical components. This warping can affect the performance of the optical component by changing the index of refraction of the light transmitting medium. As a result, there is a need for a component that is associated with a reduced level of warping.

### SUMMARY OF THE INVENTION

The invention relates to a method of forming an optical component. The method includes forming a first medium on a base. The base has one or more pockets defined in a side of the base. The first medium is formed on the base such that the first medium is positioned over the one or more pockets. The method also includes converting at least a portion of the first medium to a light transmitting medium.

In some instances, the method also includes etching the light transmitting medium so as to define one or more waveguides in the light transmitting medium. Each waveguide can be defined over a pocket.

In some instances, the first medium is attached to one or more other layers of media before the first medium is bonded to the base and the method includes removing at least one of the one or more other layers of media before converting the first medium to the light transmitting medium.

In some instances, the portion of the base on which the first medium is constructed of the same material as the first medium.

In one embodiment, the portion of the base on which the first medium is formed is constructed from silicon and the first medium is constructed from silicon. The first medium is converted from silicon to silica. In some instances, converting the silicon to silica includes performing a thermal oxide treatment.

The invention also relates to a component for formation of an optical component. The component includes a base having one or more pockets formed in a side of the base. A first medium is positioned over the side of the base such that the first medium extends over the one or more pockets. The portion of the base adjacent to the first medium is constructed from the same material as the first medium.

In one embodiment of the invention, the portion of the base adjacent to the first medium the base and the first medium are constructed from silicon.

In some instances, the one or more pockets contain a gas.

### BRIEF DESCRIPTION OF THE FIGURES

FIG. 1A is a top view of a portion of a component having a waveguide

FIG. 1B is a cross section of the portion of the component illustrated in FIG. 1A taken at the line labeled A.

FIG. 2 illustrates the base having a composite construction.

FIG. 3A illustrates an optical component having a ridge positioned in a pocket.

FIG. 3B illustrates an optical component having a ridge positioned in a pocket. The base has a composite construction.

FIG. 3C illustrates an optical component having a first ridge positioned in a pocket and a second ridge that extends away from the pocket.

FIG. 4A through FIG. 4C illustrate an optical component having an alignment region configured to provide alignment between an optical fiber and a facet of a waveguide.

FIG. 4D through FIG. 4F illustrate the alignment region providing alignment between the facet and an optical fiber.

FIG. 4G illustrates a waveguide ending in a facet that is angled at less than ninety degrees relative to a longitudinal axis of the waveguide. The facet is perpendicular to the top side of the waveguide.

FIG. 5A is a cross section of a component having a plurality of waveguides.

FIG. 5B is a top view of a component having a plurality of waveguides. Each waveguide is illustrated as being associated with an independent pocket.

FIG. 5C is a top view of component having a plurality of waveguides where a pocket is associated with more than one waveguide.

FIG. 6A is a cross section of a component having a plurality of waveguides formed over a base. The waveguides are formed of a light transmitting medium that includes one or more surface extending from the base.

FIG. 6B is a top view of the component shown in FIG. 6A.

FIG. 6C is a cross section of a component having a plurality of waveguides formed over a base. The waveguides are formed of a light transmitting medium that includes one or more surface extending from the base. The base has a composite construction.

FIG. 6D is a cross section of a component having a plurality of waveguides formed over a base.

FIG. 7A through FIG. 7F illustrates a method for forming a component according to the present invention.

FIG. 8A through FIG. 8E illustrates a method for forming a component according to the present invention.

FIG. 9A illustrates a base having a composite construction.

FIG. 9B illustrates a portion of a base converted to a light transmitting medium.

### DETAILED DESCRIPTION OF THE PREFERRED EMBODIMENT

The invention relates to a method of forming an optical component. The method includes forming a first medium on a base. The base has one or more pockets defined in a side of the base. The first medium is formed on the base such that the first medium is positioned over the one or more pockets. The method also includes converting at least a portion of the first medium to a light transmitting medium. The light transmitting medium can be etched so as to define one or more waveguides in the light transmitting medium.

The first medium and the portion of the base adjacent to the first medium can be constructed from the same material. As a result, the first medium is easily bonded to the base and the component yield is increased. Additionally, when the base and the first medium are constructed from the same material, the warping associated with different coefficients of thermal expansion is reduced. Accordingly, the component is associated with a reduced level of warping.

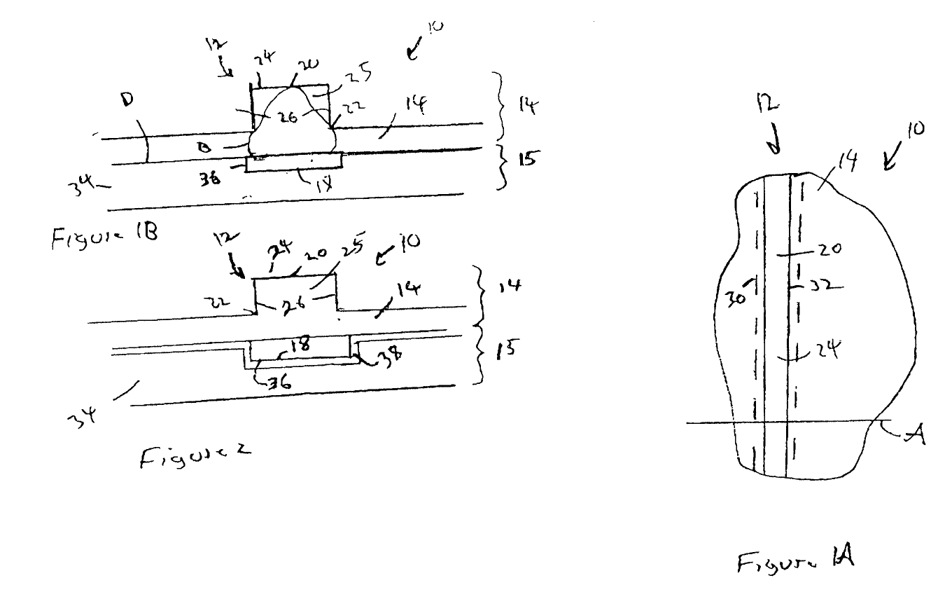

FIG. 1A is a top view of a portion of a component 10 having a waveguide. FIG. 1B is a cross section of the portion of the component 10 illustrated in FIG. 1A taken at the line labeled A. The component 10 includes a light transmitting medium 14 formed over a base 15. Suitable light transmitting media include, but are not limited to, silicon and silica. The base 15 includes a pocket 18. The light transmitting medium 14 includes a ridge 20 positioned over the pocket 18. The ridge 20 has a base 22, a top 24 and opposing sides 26. The ridge 20 defines a portion of a light signal carrying region 25. The profile of a light signal being carried in the light signal carrying region is illustrated by the line labeled B (see FIG. 1B).

The pocket 18 can hold a material that reflects light signals from the light signal carrying region back into the light signal carrying region. For instance, the pocket 18 can hold a gas such as air or another medium with an index of refraction that is less than the index of refraction of silica. The drop in index of refraction causes reflection of the light signals that are incident on the material in the pocket 18. Accordingly, the material in the pocket 18 restrains the light signals to the light signal carrying region.

FIG. 1A shows the periphery of the pocket 30 relative to the periphery of the ridge 32. The periphery of the pocket 30 is illustrated as a dashed line. The ridge 20 is positioned over the pocket 18 and the periphery of the pocket 30 traces the periphery of the ridge 32. For instance, the distance between the ridge base 22 and the periphery of the pocket 30 can be substantially constant along the length of at least a portion of the waveguide.

The pocket 18 and the ridge 20 can be constructed such that the periphery of the pocket 30 extends beyond the periphery of the ridge 32. In some instances, the pocket 18 and waveguide 12 are constructed such that the periphery of the pocket 30 is substantially the same size as the periphery of the ridge 32. In other instances, the pocket 18 and the ridge 20 are constructed such that the periphery of the pocket 30 is smaller than the periphery of the ridge 32.

In some instances, the width of the pocket 18 is larger than 200% of the width of the ridge base 22. In other instances, the width of the pocket 18 is less than 200% of the ridge base 22 width, less than 150% of the ridge base 22 width, less than 140% of the ridge base 22 width, less than 130% of the ridge base 22 width, less than 120% of the ridge base 22 width, less than 110% of the ridge base 22 width, less than 100% of the ridge base 22 width. When a pocket 18 is employed with another type of waveguide, the pocket 18 can have the same dimensional relationships to the width of the waveguide 12 that is employed with respect to the ridge 20.

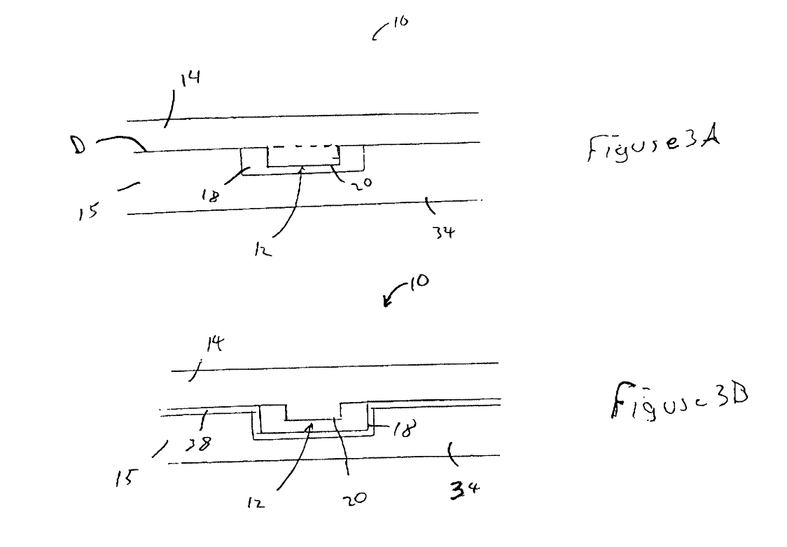

The base 15 can include a substrate 34 such as a silicon substrate 34. As shown in FIG. 1B, the substrate 34 can have one or more surface 36 that define a pocket 18 in the substrate 34. Alternatively, the base can have a composite construction. For instance, one or more layers of material can be formed over the substrate as shown in FIG. 2. Suitable layers of material include, but are not limited to, silica.

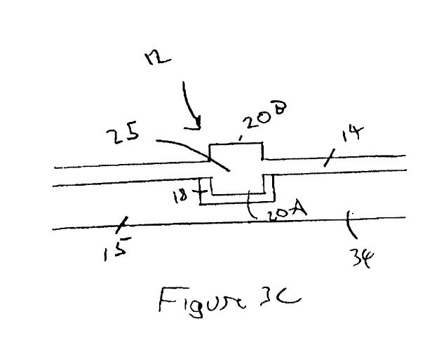

The ridge 20 can be inverted so the ridge 20 is positioned in the pocket 18 as shown in FIG. 3A. Positioning the ridge 20 in the pocket 18 protects the ridge 20 from physical damage. For example, the position of the ridge 20 in the pocket 18 can protect the ridge 20 from damage that can occur during the handling of the component 10. The base can have a composite construction as shown in FIG. 3B.

The light transmitting medium 14 can have a first ridge 20A that extends into the pocket 18 and a second ridge 20B that extends away from the pocket 18 as illustrated in FIG. 3C. The first ridge 20A can have the same or a different shape than the second ridge 20B. For instance, the second ridge 20B can be wider, narrower, taller and/or shorter than the first ridge 20A.

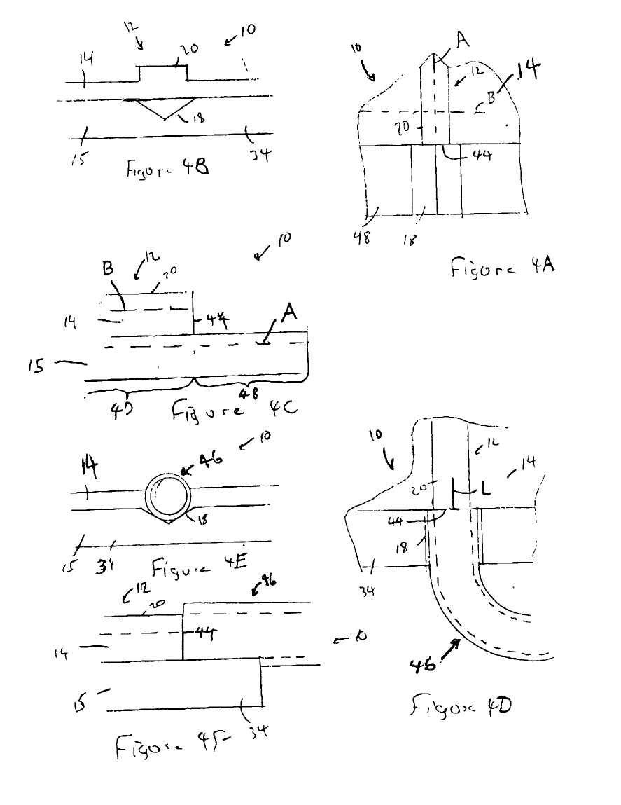

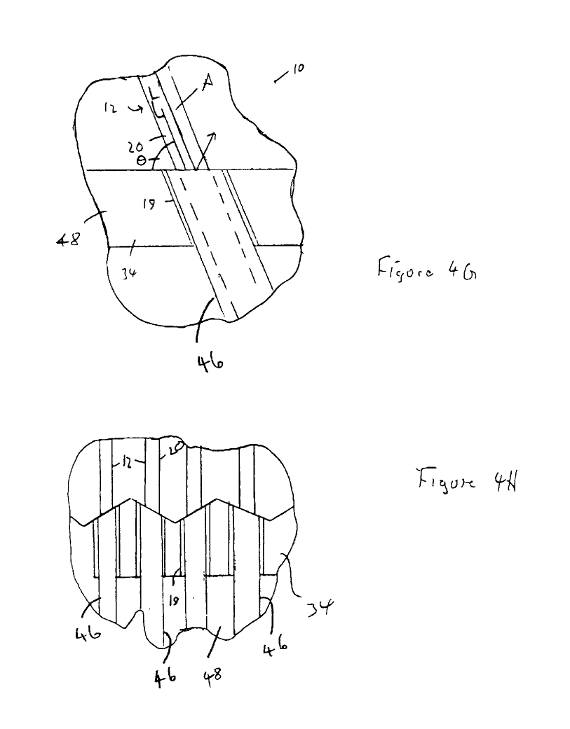

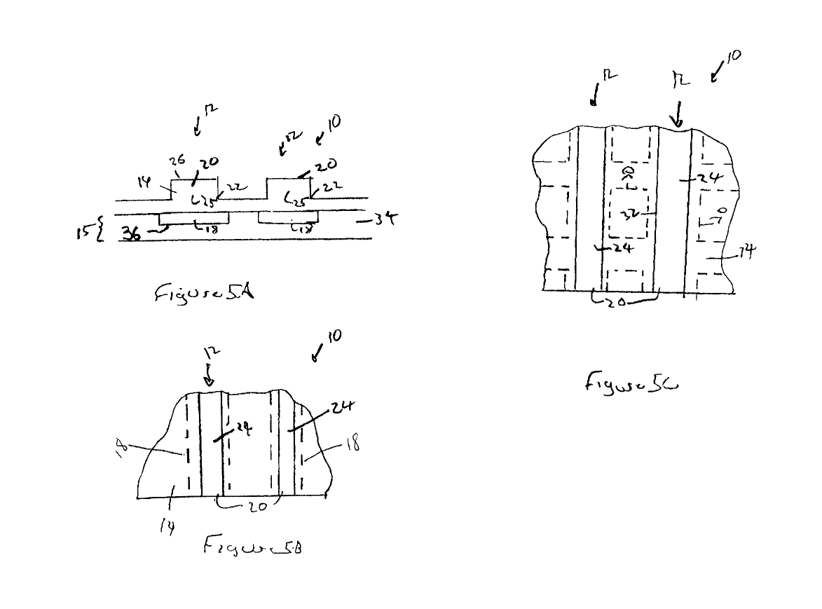

The light signal carrying regions of the waveguides on the component can end at a facet. The pocket 18 can serve to align an optical fiber with the facet. For instance, FIG. 4A through FIG. 4C illustrate a component 10 having an alignment region 48 for aligning an optical fiber 46 with a facet 44. FIG. 4A is a top view of an optical component 10 having an alignment region 48. FIG. 4B is a cross section of FIG. 4A taken at the line labeled B. FIG. 4C is a cross section of the component 10 illustrated in FIG. 4A taken along the line labeled A. The dashed line labeled A in FIG. 4A shows the location of the bottom of the pocket 18 while the dashed line labeled B shows the location of the base of the ridge.

The base 15 includes a support region 47 adjacent to an alignment region 48. The light transmitting medium 14 is positioned over the support region 47 but not positioned over the alignment region 48. The alignment region 48 is positioned adjacent to the facet 44 and extends away from the support region 47 at a substantially right angle relative to the facet 44. The pocket 18 extends from under the light signal carrying region 25 and into the alignment region 48.

The alignment region 48 is configured to align the optical fiber 46 in a desired orientation relative to the facet 44 as illustrated in FIG. 4D through FIG. 4F. FIG. 4D through FIG. 4F correspond to FIG. 4A through FIG. 4C with the optical fiber 46 received within the pocket 18. The illustrated optical fiber 46 has a cladding although the alignment region can be employed in conjunction with optical fibers without a cladding. The position of the cladding relative to the waveguide 12 is illustrated by a dashed line.

The pocket 18 is sized so as to receive the optical fiber 46 such that the optical fiber 46 has a particular orientation relative to the facet 44. For instance, the pocket 18 can be centrally positioned relative to the facet 44. Accordingly, when the optical fiber 46 is positioned in the pocket 18, the center of the optical fiber 46 is aligned with the center of the facet 44. The depth of the pocket 18 can be selected to position the height of the optical fiber 46 relative to the waveguide 12. For instance, a deeper and wider pocket 18 causes the optical fiber 46 to sit lower relative to the waveguide 12 while a narrow shallow pocket 18 can raise the optical fiber 46 relative to the waveguide 12.

Although the pocket 18 in the self-alignment region 48 is shown as having a v-shape, the pocket 18 can have other shapes that provide self-alignment. For instance, the pocket 18 can have a semi-circular shape with the deepest part of the semi-circle centered relative to the facet. The semi-circle can have a shape that is complementary to the shape of the optical fiber 46 so the optical fiber fits snugly in the pocket 18. A pocket 18 that is snug on the optical fiber 46 reduces the possible range of movement of the optical fiber 46 relative to the waveguide 12.

Although the pocket 18 is shown as having a substantially rectangular shape, the pocket 18 can have other shapes including, but not limited to, semi-circular, semi-oval and a v-shape. FIG. 4A illustrates a component 10 having a v-shaped pocket 18.

An optical fiber can be coupled with the facet by positioning an index of refraction matching oil and/or an index of refraction matching epoxy between the facet and the optical fiber. Additionally, the optical fiber can be coupled with the pocket 18 to further immobilize the optical fiber relative to the alignment region.

The discussion of the alignment region presumes that the optical fiber is preferably centered relative to the facet, however, the alignment region can also be configured to align an optical fiber such that the optical fiber is not centered relative to the waveguide.

Although the above discussion of the alignment region is directed toward waveguides having a ridge that extends away from the pocket 18, the alignment region can also be associated with waveguides having a ridge that extends into the pocket 18.

FIG. 4A through FIG. 4F illustrate the facet 44 as being perpendicular to a longitudinal axis, L, of the waveguide 12 at the end of the waveguide. However, the facet 44 can be angled relative to the longitudinal axis L as shown by the angle labeled θ in FIG. 4G. The facet is substantially perpendicular relative to the base. The angle can cause light that is reflected by the facet to be reflected out of the waveguide as illustrated by the arrow labeled A. Directing the reflected light out of the waveguide prevents the reflected light from resonating within the waveguide and accordingly improves performance of the waveguide.

Reducing the angle θ can result in increased insertion losses. As a result, there is a balance between increased insertion losses and reduced resonance. Suitable angles θ include, but are not limited to, less than 90 degrees, less than 89 degrees, 45-90 degrees, 60-89 degrees, 70-88 degrees, 80-87 degrees, 81-86 degrees, 81.5-84.5 degrees, 82-84 degrees or 82.5-83.5 degrees.

When a component includes a plurality of waveguides, the direction of the facet angle on adjacent waveguides can be alternated so as to provide a zig zag configuration of facets as illustrated in FIG. 4H. The component can also be constructed so the facet direction is alternated less frequently than every facet. The angle θ is presumed to be an absolute value measurement, in that a facet positioned at an angle of 271 degrees relative to the longitudinal axis is presumed to be positioned at an angle of 89 degrees. Accordingly, each of the facets in FIG. 4H are considered to have the same angle θ although they are angle in opposing directions.

When the waveguide facet 44 is angled, the optical fiber also has a facet that is angled relative to the longitudinal axis of the optical fiber. The angle of the optical fiber facet is complementary to the angle of the facet on the waveguide. The complementary angles allow the optical fiber to be coupled to waveguide with the longitudinal axis of the waveguide aligned with the longitudinal axis of the optical fiber.

Although the angled facet discussed above is disclosed in conjunction with an alignment region, an angled facet can be formed at an edge of a component when an alignment region is not formed. Further, the component 10 can include angled facets when the ridge 20 extends into the pocket 18.

As discussed above, the pocket 18 can be filled with a gas such as air. When the pocket 18 is filled with a gas, the component can be constructed such that the gas is isolated form the atmosphere. In some instances, the gas is isolated from the atmosphere such that the gas in the pocket 18 is under a different pressure than the ambient atmosphere. In some instances, the gas in the pocket 18 is under a vacuum in that the gas is at less than atmospheric pressure. The vacuum serves to provide thermal insulation to the waveguide and can increase reflection of the light signals from the light signal carrying region. Alternatively, the pocket 18 can be filled with a material having an index of refraction less than the index of refraction of the light transmitting medium 14. For instance, when the light transmitting medium 14 is silica, the pocket 18 can be filled with a low dielectric constant, K, material having an index of refraction that is less than the index of refraction of silica. Suitable low K materials have a K less than about 1.5. Examples of low K materials include, but are not limited to, SiCOH. The pocket 18 can also be filled with a material having reflective properties. For instance, the pocket 18 can be filled with a reflective metal. When the light signal carrying medium is formed of a light transmitting medium other than silica, the low K material has an index of refraction less than the index of refraction of the light transmitting medium.

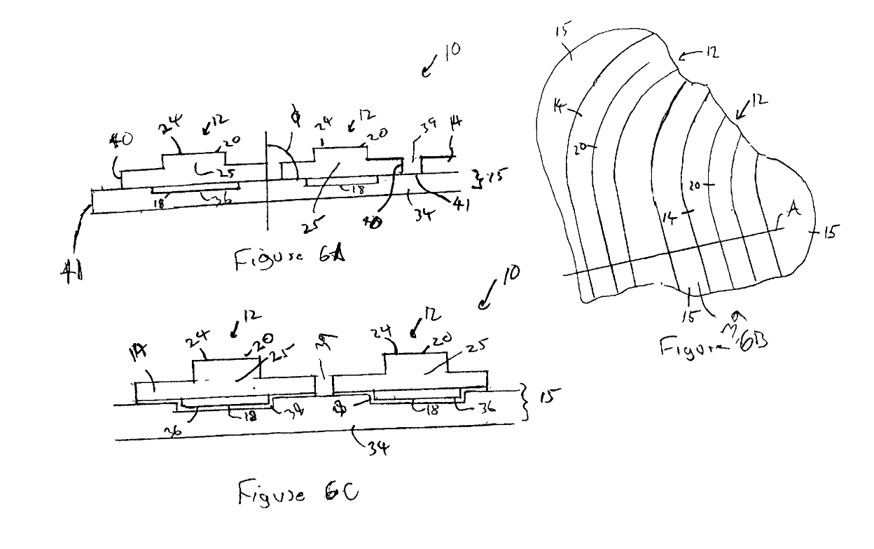

Although FIG. 1A through FIG. 4G illustrate a component 10 having a single waveguide, the component 10 can include a plurality of waveguides as shown in FIG. 5A. An example of an optical component 10 including a plurality of waveguides is a de-multiplexer having an arrayed waveguide grating.

A different pocket 18 can be associated with each waveguide. For instance, FIG. 5B is a top view of a component 10 where a portion of each ridge 20 is associated with a different pocket 18. Alternatively, the pockets 18 under different ridge 20 can be in communication. For instance, FIG. 5C illustrates a component 10 having a pocket 18 that extends under more than one ridge 20. The portion of the base 15 that defines the side of the pocket 18 supports the light transmitting medium 14 over the base 15.

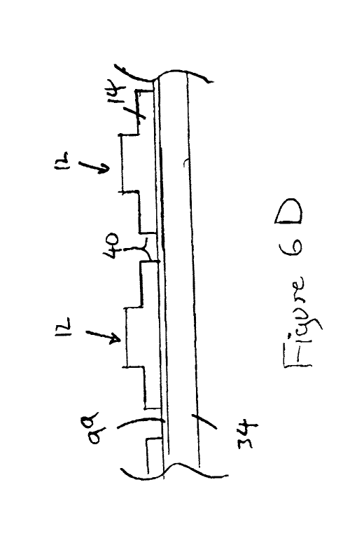

The light transmitting medium 14 associated with adjacent waveguides can be separated by a gap 39 as shown in FIG. 6A and FIG. 6B. FIG. 6B is a top view of an optical component having two waveguides positioned adjacent to one another. FIG. 6A is a cross section of the component shown in FIG. 6B taken at the line labeled A. The gap 39 is partially defined by the base and one or more surfaces of the light transmitting medium 14 that intersect with the base. The one or more surfaces are shown as intersecting the base remote from a lateral side of the base although the one or more surfaces can intersect the base at a lateral side of the base so the lateral side 41 and the surface together define the lateral side of the component. The ridge of the waveguides can be centrally positioned between two surfaces 40 or can be off center relative to the surfaces 40. In some instances, the one or more surfaces are substantially perpendicular to the base.

When a component includes a single waveguide or waveguides that are not adjacent to one another, the light transmitting medium 14 may include surfaces 40 that interface the base without forming a gap 39.

The surfaces 40 can provide isolation of the waveguides from one another and accordingly help reduce the amount of cross talk between adjacent waveguides. Light signals that exit the light signal carrying region can be reflected off the surface back into the waveguide or transmitted through the surface. Light signals transmitted through the surface can exit the gap into the atmosphere or be reflected off another surface of the groove. As a result, the amount of light that exits the light signal carrying region and enters another light signal carrying region is reduced. As a result, cross talk between adjacent waveguides is also reduced.

As shown in FIG. 6A, the base 15 extends away from the surface at an angle, φ, less than 180 degrees. In other instances, the base 15 extends away from the surface at an angle, φ, less than 170 degrees, less than 140 degrees and less than 100 degrees. The base 15 preferably extends away from the surface at about 90 degrees. Accordingly, the base 15 serves as the bottom of the gap 39.

The gap 39 holds a medium that causes light signals from the light transmitting medium 14 to be reflected back into the light transmitting medium 14. For instance, the gap can hold ambient air. The low index of refraction of the ambient air causes reflection of the light signals are the surface 40. The gap can be filled with other media such as solids.

The surface extends along at least a portion of the longitudinal length of the waveguides. The longitudinal length is parallel to the direction of propagation of the light signals along the waveguide. In some cases the surface does not extend along the entire longitudinal length of the waveguide. For instance, when two waveguides intersect, the surface may intersect with the surface of another waveguide before the intersection of the light signal carrying regions associated with the waveguides.

In some instances, the surface 40 substantially traces the waveguide. For instance, the intersection of the surface 40 with the base can be substantially equidistant from a reference location that extends along the longitudinal length of the waveguide. When the waveguide is a ridge waveguide, a suitable reference point is the base of the ridge 20.

Although the gap is shown as extending only to the level of the base in FIG. 6A and FIG. 6B, the gap can extend into the base 15. For instance, FIG. 6C illustrates an embodiment of the component having a composite construction with a layer of material 38 positioned over a substrate. The surfaces 40 extend through the layer of material 40. Although not illustrated, the surfaces 40 can also extend into the substrate.

The advantages provided by forming the surfaces in the light transmitting medium can also be gained with traditional base constructions. For instance, FIG. 6D illustrates waveguides formed over a base having a continuous light barrier 99 formed over a substrate. The light barrier serves to reflect light signals from the waveguides 12 back into the waveguides 12. The surfaces 40 isolate the waveguides from one another.

The surfaces 40 illustrated in the light transmitting medium of FIG. 6A through FIG. 6C can be employed in conjunction with other waveguide types such as channel waveguides. For instance, the surfaces can be formed in the light transmitting medium associated with the waveguide illustrated in FIG. 3A and FIG. 3B.

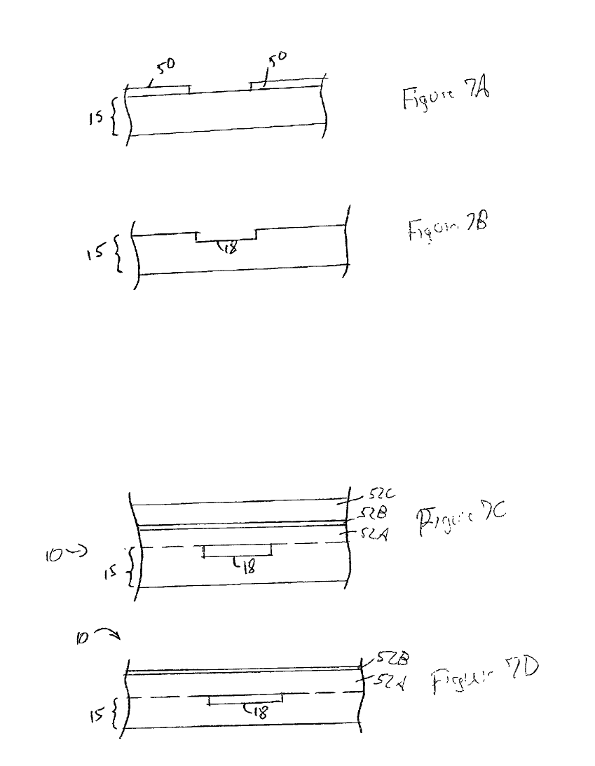

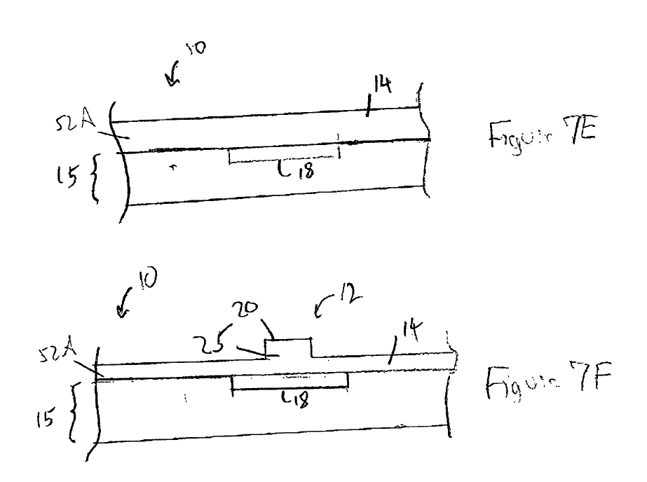

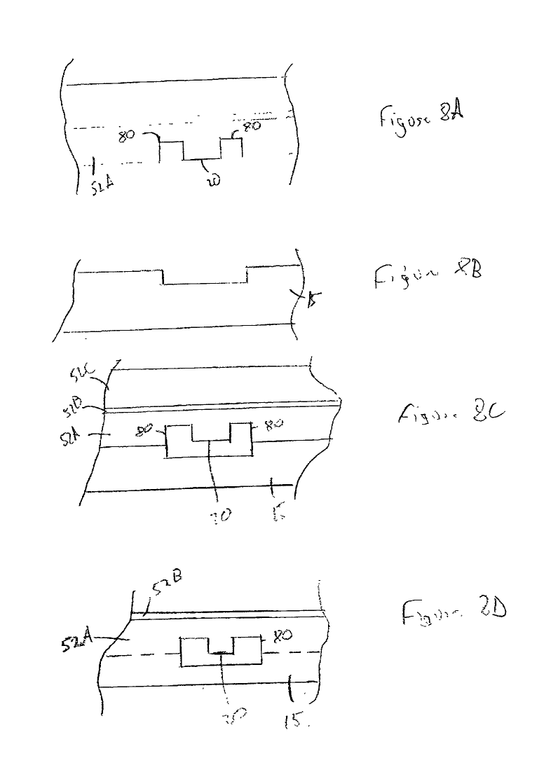

FIG. 7A to FIG. 7F illustrate a method for forming a component 10 having a waveguide 12. The method can be easily adapted to forming a component 10 having a plurality of waveguides 12. A mask 50 is formed on a base 15 so as to provide the base 15 shown in FIG. 7A. A suitable base 15 is constructed from a silicon wafer.

The mask 50 is formed such that the regions of the base 15 where the pockets 18 are to be formed remain exposed. An etch is performed so as to form the pockets 18 to the desired depth. Air or another gas can be left in the pockets 18. Alternatively, a material such as a low K material can be deposited in the pockets 18. The mask 50 is removed to provide the base 15 shown in FIG. 7B. When the base has a crystalline structure, the pockets 18 can be provided with a v-shape by performing a wet etch along the <111> crystal orientation.

A first medium 52A is formed on the base 15 as shown in FIG. 7C. The interface of the first medium 52A and the base 15 is illustrated as a dashed line because the first medium 52A and the portion of the base 15 adjacent to the first medium 52A can be constructed from the same material. Suitable methods of forming the first medium 52A on the base 15 include, but are not limited to, growing the first medium 52A on the base 15, depositing the first medium 52A on the base 15 or bonding the first medium 52A to the base 15 using a technique such as wafer bonding. When wafer bonding is employed, the first medium 52A can be attached to one or more other media. For instance, the first medium illustrated in FIG. 7C is attached to a second medium 52B and a third medium 52C. A suitable wafer having a first medium 52A, a second medium 52B and a third medium 52C is a silicon on insulator wafer. A silicon on insulator wafer typically has a silica layer positioned between a first silicon layer and a second silicon layer. The first silicon layer serves as the first medium 52A, the silica layer serves as the second medium 52B and the second silicon layer serves as the third medium 52C.

The third medium 52C is removed to provide the component 10 shown in FIG. 7D. Suitable methods for removing the third medium 52C include, but are not limited to, etching and polishing.

The first medium 52A is converted to the light transmitting medium 14 as shown in FIG. 7E. For instance, when the first medium 52A is silicon, the first medium 52A can be converted to silica. The second medium 52B can be different from the light transmitting medium 14 or the same as the light transmitting medium 14. In the illustrated embodiment, the second medium 52B is the same as the light transmitting medium 14. As a result, the interface between the second medium 52B and the light transmitting medium 14 is not illustrated.

Converting the first medium 52A can include changing the chemical composition of the first medium 52A, injecting a material into the first medium 52A and or changing the structure of the first medium 52A. An example of changing the structure of the first medium includes changing a crystalline structure of the first medium 52A into another crystalline structure. When the first medium 52A is silicon, the first medium can be converted to silica by performing a thermal oxide treatment on the component. The temperature and duration of the thermal oxide treatment determine the depth to which the silicon is converted to silica. Although not shown, when the base 15 is constructed from silicon, the thermal oxide treatment can convert exposed portions of the base 15 to silica.

When the second medium 52B is different than the light transmitting medium 14, the second medium 52B can be removed. Alternatively, the second medium 52B can remain in place when the first medium 52A is converted to the light transmitting medium 14. In response to converting the first medium 52A to the light transmitting medium 14, the second medium 52B can be converted to another medium or can remain the same. Because the second medium 52B remains in place on the component, the second medium can serve as a protective layer.

The light transmitting medium 14 is masked such that the locations where the ridge(s) 20 are to be formed are protected. An etch is then performed so as to form the ridge 20 to the desired height. The mask 50 is removed to provide the component 10 shown in FIG. 7F.

Although FIG. 7A through FIG. 7F illustrate the ridge 20 formed after the first medium 52A is converted to the light transmitting medium 14, the ridge 20 can be formed in the first medium 52A before the first medium 52A is converted into the light transmitting medium 14.

The method of FIG. 7A through FIG. 7F can be adapted to form a component such as the component illustrated in FIG. 3A through FIG. 3C. For instance, the pocket(s) 18 can be formed to a size needed to receive a ridge 20. A ridge(s) 20 to be positioned in the pocket(s) 18 can be formed in the first medium 52A before the first medium 52A is formed on the base 15. The ridge(s) 20 is then positioned in the pocket(s) 18 when the first medium 52A is formed on the base 15.

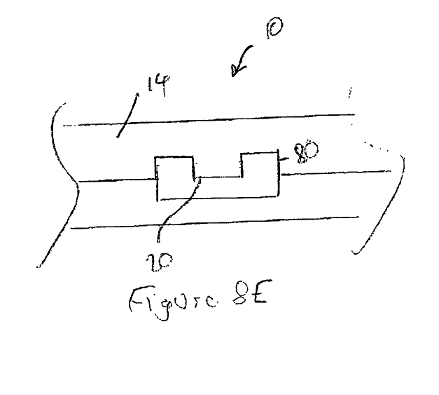

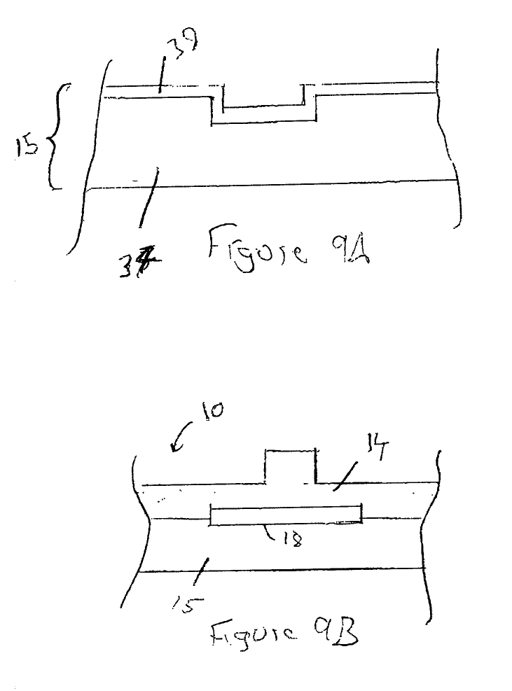

Another adaptation of the method to form a component having a ridge 20 positioned in a pocket 18 is illustrated in FIG. 8A through FIG. 8E. A first medium 52A is masked and etched so as to provide the first medium 52A shown in FIG. 8A. The first medium 52A includes trenches 80 positioned so as to define sides of the ridge 20. The width, W, of the trenches 80 and the ridge 20 approximates the width of the pocket 18 to be formed in the base 15.

A base 15 is masked and etched so as to provide the base 15 shown in FIG. 8B. The first medium 52A is formed on the base 15 as shown in FIG. 8C. A portion of the base 15 and a portion of the first medium 52A define the pocket 18. The interface of the first medium 52A and the base 15 is illustrated as a dashed line because the first medium 52A and the portion of the base 15 adjacent to the first medium 52A can be constructed from the same material. Suitable methods for forming the first medium 52A on the base 15 include, but are not limited to, wafer bonding techniques.

As illustrated in FIG. 8A, the first medium 52A can be attached to one or more other media. For instance, the first medium 52A illustrated in FIG. 8A is attached to a second medium 52B and a third medium 52C. The third medium 52C is removed to provide the component 10 shown in FIG. 8D. Suitable methods for removing the third medium 52C include, but are not limited to, etching and polishing.

The first medium 52A is converted to the light transmitting medium 14 as shown in FIG. 8E. For instance, when the first medium 52A is silicon, the first medium 52A can be converted to silica. The second medium 52B can be different from the light transmitting medium 14 or the same as the light transmitting medium 14. In the illustrated embodiment, the second medium 52B is the same as the light transmitting medium 14. As a result, the interface between the second medium 52B and the light transmitting medium 14 is not illustrated. When the second medium 52B is different than the light transmitting medium 14, the second medium 52B can be removed. Alternatively, the second medium 52B can remain in place when the first medium 52A is converted to the light transmitting medium 14.

The component 10 of FIG. 7D through FIG. 7F or FIG. 8C through FIG. 8E can be further treated so as to form the surfaces 40 discussed with respect to FIG. 6A through FIG. 6D. For instance, the component 10 can be masked such that the regions where a gap(s) 39 is to be formed is exposed. When a gap 39 will not be formed the component 10 is masked so a side of the mask is aligned with the desired locations of the one or more surfaces 40. The exposed regions can then be etched and the mask removed so as to form the one or more surfaces 40. The surfaces are formed to the desired depth. Material(s) to be formed in the gap 39 can be formed in the gap 39 before and/or after removal of the mask. The one or more surfaces can be formed before or after formation of the ridge 20.

In the methods illustrated above, the combined thickness of the first medium 52A and the second medium 52B becomes the thickness of the ridge 20. When the combined thickness of the first medium 52A and the second medium 52B exceeds the desired ridge thickness, the second medium can be removed to provide the desired ridge thickness. Accordingly, in some instances, the third medium 52C and the second medium 52B can be entirely removed before converting the first medium. In some instances, a portion of the first medium can also removed to provide the desired ridge thickness. As an alternative to removing the first medium 52A after the first medium 52A is formed on the base 15, the first medium 52A can be removed before the first medium 52A is formed on the base 15.

The first medium 52A need not be attached to other media before the first medium is formed on the base. For instance, when the first medium 52A is silicon, a silicon wafer can be bonded to the base 15. As a result, there is no need to remove the second medium 52B and/or the third medium 52C. When the first medium 52A is thicker than the desired ridge thickness, the top of the first medium 52A can be removed to provide the first medium 52A with the desired ridge thickness. As an alternative to removing the first medium 52A after the first medium 52A is formed on the base 15, the first medium 52A can be removed before the first medium 52A is formed on the base 15.

As noted above, a gas in the pocket 18 can be isolated from the atmosphere. In some instances, the gas in the pocket 18 is isolated from the atmosphere such that the gas is at a different pressure than the atmosphere.

A gas in a pocket 18 can be isolated from the atmosphere by positioning sealing members in the pocket 18 so as to form a chamber in the pocket 18. The gas in the chamber is sealed from the atmosphere. The sealing members can be positioned such that a chamber is formed along the entire length of a pocket 18 or such that a chamber is formed along a portion of the length of a pocket 18. Further, the sealing members can be positioned such that more than one chamber is formed in a pocket 18. Additionally, pockets associated with different waveguides may intersect. The sealing members may be positioned such that a chamber extends from a pocket 18 associated with a waveguide into the pocket 18 associated with one or more other waveguides. Accordingly, a pocket 18 associated with a waveguide can have a single sealing member and the gas in that pocket 18 can be isolated from the atmosphere.

A suitable method of forming a sealing member between the base and the light transmitting medium is injecting a fluid sealing member precursor between the base 15 and the light transmitting medium 14. Suitable sealing member precursors include, but are not limited to, glues, adhesives and epoxies in their fluid state. Once the sealing member precursor is located in the pocket 18, the sealing member precursor can transition to a solid that serves as the sealing member.

Although the sealing member precursor is described as being positioned in the pocket 18 after the light transmitting medium 14 is formed adjacent to the base 15, the sealing member precursors can be positioned in the pocket 18 before the first medium is formed on the base 15. The first medium can 52A be formed on the base 15 when the sealing member precursor is in a fluid state to allow the sealing member precursor to bond to the first medium 52A and hence the light transmitting medium 14. Alternatively, the sealing member precursor can be positioned in the pocket 18 after the first medium 52A is formed on the base and before the first medium is 52A converted to the light transmitting medium 14.

As an alternative to employing a fluid sealing member precursor, the sealing member precursor can be integral with the base. For instance, when the pocket 18 is formed in the base, the pocket 18 can be formed such that portions of the base extend across the pocket 18 so as to define the ends of a pocket 18. When the first medium 52A is formed on the base 15, the first medium bonds to the portion of the base extending across the pocket 18. As a result, the gas located between the portions of the base that define the ends of the pocket 18 is isolated from the atmosphere.

A vacuum can be formed by heating the component 10 to react the oxygen in the sealed pocket(s) 18 with the light transmitting medium and/or the base. For instance, when the pockets 18 are formed in a silicon substrate and the gas in the pocket 18 is air, the oxygen in the air can react with the silicon to form silica. Heating the component can be for the purpose of catalyzing the reaction or can be part of a fabrication step such as bonding the first medium 52A to the base 15. The reaction of the oxygen reduces the pressure in the pocket 18 because the amount of gas in the sealed pocket 18 is reduced. When one or more layers of material 38 are formed in the pocket 18, the one or more layers of material 38 can be selected so as to catalyze the reaction between the gas in the pocket 18 and the one or more layers of material 38.

A vacuum can also be formed in the pocket 18 by forming the first medium 52A adjacent to the base 15 in a chamber held at the pressure desired in the pocket 18 or by positioning a fluid sealing member precursor in a chamber held at the pressure desired in the pocket 18. In either of these methods the pressure that results in the pocket 18 will be substantially the same as the pressure in the chamber. The pressure in the pocket 18 can be reduced further by heating the component to react the material in the pocket 18 with the light transmitting medium or the sides of the pocket 18.

The above methods of forming a vacuum can be employed to provide the material in the pocket 18 with a pressure of less than about 1 atmospheres (atm), 0.95 atm, 0.9 atm, 0.85 atm, 0.8 atm, 0.75 atm, 0.7 atm, 0.6 atm, 0.5 atm or 0.4 atm.

Many variations of the methods discussed with respect to FIG. 7A through FIG. 8E are possible. For instance, the method can include formation of a base 15 with a composite construction. One or more layers of material 38 can be formed over the base 15 as shown in FIG. 9A before the first medium 52A is formed on the base 15. The top layer of material 38 can be the same as the first medium 52A in order to facilitate the use of wafer bonding techniques. Suitable methods for forming the layer of material 38 include, but are not limited to, growing the layer of material 38 on the base 15, depositing the layer of material 38 on the base 15 and converting a portion of the base 15 to the layer of material 38. When the base 15 is constructed from silicon, the top of the base 15 can be converted to a layer of silica by performing a thermal oxide treatment. Although the layer of material 3 8 is shown as being formed over the entire base 15, masking techniques can be employed so the layer of material 38 is limited to the pocket 18 or outside the pocket 18.

Although FIG. 7E and FIG. 8E illustrates the first medium 52A converted to the light transmitting medium 14 down to the level of the base 15, all or a portion of the base 15 can be converted to the light transmitting medium 14 as illustrated in FIG. 9B. For instance, when the first medium and portion of the base adjacent to the first medium are both silicon, and the first medium is converted to silica, the portion of the base adjacent to the first medium can also be converted to silica.

In some instances, the first medium 52A is the light transmitting medium 14. In these instances, the first medium 52A need not be converted to light transmitting medium 14. As a result, the waveguide 12 can be defined directly in the first medium 52A. For instance, the ridge 20 of the waveguide 12 can be formed in the first medium 52A of the components shown in FIG. 7D. When the first medium 52A and the base 15 are constructed from the same material, the resulting component does not exhibit warping due to different coefficients of thermal expansion. When the base 15 has a composite construction and the portion of the base 15 adjacent to the first medium 52A is constructed from the same material as the first medium 52A, the component yield is increased and warping due to different coefficients of thermal expansion is reduced.

Some of the etch(es) employed in the method described above can result in formation of a facet and/or in formation of the sides of a ridge 20 of a waveguide 12. These surfaces are preferably smooth in order to reduce optical losses. Suitable etches for forming these surfaces include, but are not limited to, reactive ion etches, the Bosch process and the methods taught in U.S. patent application Ser. No. 09/690,959; filed on Oct. 16, 2000; entitled “Formation of a Smooth Vertical Surface on an Optical Component” and incorporated herein in its entirety and U.S. patent application Ser. No. 09/845,093; filed on Apr. 27, 2001; entitled “Formation of an Optical Component Having Smooth Sidewalls” and incorporated herein in its entirety.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. A method of forming an optical component, comprising:
forming a first medium on a base having one or more pockets such that the first medium is positioned over the one or more pockets; and
converting at least a portion of the first medium to a light transmitting medium.

2. The method of claim 1, wherein a portion of the base on which the first medium is formed and the first medium are constructed of the same material.

3. The method of claim 1, wherein the one or more pockets contain a medium that causes reflection of a light signal traveling through the light transmitting medium back into the light transmitting medium.

4. The method of claim 3, wherein the one or more pockets contains air.

5. The method of claim 3, wherein the first medium is formed on the base such that the medium in the one or more pockets is isolated from the atmosphere.

6. The method of claim 1, further comprising:
etching the light transmitting medium so as to define a waveguide in the light transmitting medium.

7. The method of claim 6, wherein etching the light transmitting medium so as to define the waveguide includes:
etching a ridge in the light transmitting medium.

8. The method of claim 7, wherein the ridge is formed over a pocket.

9. The method of claim 1, wherein the first medium is attached to one or more other layers of media before the first medium is bonded to the base.

10. The method of claim 9, wherein one of the one or more layers of media is constructed of the same material as the light transmitting medium.

11. The method of claim 9, further comprising:
removing at least one of the one or more other layers of media before converting the first medium to the light transmitting medium.

12. The method of claim 1, wherein all the first medium is converted to the light transmitting medium.

13. The method of claim 1, wherein all of the first medium is converted to the light transmitting medium and a portion of the base adjacent to the first medium is converted to the light transmitting medium.

14. The method of claim 1, wherein the base and the first medium are constructed of silicon.

15. The method of claim 14, wherein converting the first medium to the light transmitting medium includes converting the silicon to silica.

16. The method of claim 15, wherein converting the first medium to the light transmitting medium includes performing a thermal oxide treatment.

17. The method of claim 1, wherein forming the first medium on the base includes bonding a wafer that includes the first medium to the base.

18. The method of claim 1, further comprising:
sealing a gas in at least one of the one or more pockets from the atmosphere.

19. The method of claim 1, further comprising:
sealing a gas in at least one of the one or more pockets such that a pressure of the sealed gas is less than 1 atm.

20. A component for formation of an optical component, comprising:
a base having one or more pockets formed in a side of the base; and
a first medium positioned over the side of the base such that the first medium extends over the one or more pockets, a portion of the base adjacent to the first medium and the first medium being constructed from the same material.

21. The component of claim 20, wherein a portion of the base adjacent to the first medium and the first medium are constructed from silicon.

22. The component of claim 20, wherein the one or more pockets contains a gas.

23. The component of claim 20, wherein the one or more pockets are constructed such that a medium in the one or more pockets is isolated from the atmosphere.

24. The component of claim 20, wherein the first medium is a light transmitting medium.

25. The component of claim 20, wherein one or more waveguides are defined in the first medium.
